(19) United States
(12) Patent Application Publication
(10) Pub. No.: US 2026/0206097 A1
(43) Pub. Date: Jul. 16, 2026

(54) DEVICE AND METHOD OF COMMUNICATION

(71) Applicant: NEC Corporation, Tokyo (JP)

(72) Inventor: Gang WANG, Beijing (CN)

(73) Assignee: NEC Corporation, Tokyo (JP)

(21) Appl. No.: 19/138,160

(22) PCT Filed: Dec. 12, 2022
(86) PCT No.: PCT/CN2022/138499

§ 371 Date: Jun. 12, 2025

(51) Int. Cl. H04W 76/40; H04W 76/27

(52) U.S. Cl. CPC H04W 76/40; H04W 76/27

(57) ABSTRACT

Embodiments of the present disclosure relate to devices and methods of communication. In one aspect, a terminal device in an inactive state determines that a control channel for multicast is to be monitored based on at least one of the following: a paging message; a timer configured for reception of a multicast session that the terminal device has joined; a modification period for monitoring of the control channel; a repetition period for monitoring of the control channel; information of the multicast session carried on the control channel; or a MAC CE indicating that the control channel is to be monitored. Upon determination that the control channel is to be monitored, the terminal device monitors the control channel for acquisition of the information of the multicast session. In this way, unnecessary monitoring may be avoided and power consumption on the monitoring may be reduced.

### TECHNICAL FIELD

Embodiments of the present disclosure generally relate to the field of telecommunication, and in particular, to devices and methods of communication for multicast and broadcast service (MBS).

### BACKGROUND

To enable resource-efficient delivery of MBS, the third generation partnership project (3GPP) has developed new radio (NR) broadcast and multicast in Release 17. In Release 17, multicast is only specified for a connected state, which may not fully fulfil requirements of some services (e.g., mission critical services) especially for cells with a large number of UEs. In addition, to always keep UEs in a connected state is not power efficient. It is therefore important to support multicast reception for UEs in an inactive state. However, if a control channel is introduced for multicast session notification, solutions for monitoring of the control channel are still incomplete and need to be further developed.

### SUMMARY

In general, embodiments of the present disclosure provide methods, devices and computer storage media of communication for monitoring of a control channel for multicast.

In a first aspect, there is provided a terminal device. The terminal device comprises a processor. The processor is configured to cause the terminal device to: determine, in an inactive state, that a control channel for multicast is to be monitored, the determining being based on at least one of the following: a paging message; a timer configured for reception of a multicast session that the terminal device has joined; a modification period for monitoring of the control channel; a repetition period for monitoring of the control channel; information of the multicast session carried on the control channel; or a medium access control control element indicating that the control channel is to be monitored; and monitor the control channel for acquisition of the information of the multicast session.

In a second aspect, there is provided a terminal device. The terminal device comprises a processor. The processor is configured to cause the terminal device to: determine, in an inactive state, that an identity of a subgroup associated with a multicast session that the terminal device has joined; receive, from a network device, information of a scheduling for a control channel for multicast; and determine a monitoring of the control channel based on the identity of the subgroup and the information of the scheduling.

In a third aspect, there is provided a method of communication. The method comprises: determining, at a terminal device in an inactive state, that a control channel for multicast is to be monitored, the determining being based on at least one of the following: a paging message; a timer configured for reception of a multicast session that the terminal device has joined; a modification period for the multicast session; a repetition period for monitoring of the control channel; information of the multicast session carried on the control channel; or a medium access control control element indicating that the control channel is to be monitored; and monitoring the control channel for acquirement of the information of the multicast session.

In a fourth aspect, there is provided a method of communication. The method comprises: determining, at a terminal device in an inactive state, that an identity of a subgroup associated with a multicast session that the terminal device has joined; receiving, from a network device, information of a scheduling for a control channel for multicast; and determining a monitoring of the control channel based on the identity of the subgroup and the information of the scheduling.

In a fifth aspect, there is provided a computer readable medium having instructions stored thereon. The instructions, when executed on at least one processor, cause the at least one processor to perform the method according to any of the third and fourth aspects of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates an example communication network in which some embodiments of the present disclosure can be implemented;

FIG. 2A illustrates a schematic diagram of a unicast scenario in which some embodiments of the present disclosure can be implemented;

FIG. 2B illustrates a schematic diagram of a multicast scenario in which some embodiments of the present disclosure can be implemented;

FIG. 3 illustrates a schematic diagram illustrating a process of communication for monitoring of a control channel for multicast according to embodiments of the present disclosure;

FIG. 4A illustrates a schematic diagram illustrating an example monitoring of a control channel based on a paging message according to embodiments of the present disclosure;

FIG. 4B illustrates a schematic diagram illustrating an example monitoring of a control channel based on a timer according to embodiments of the present disclosure;

FIG. 4C illustrates a schematic diagram illustrating a modification period and a repetition period for monitoring of a control channel according to embodiments of the present disclosure;

FIG. 4D illustrates a schematic diagram illustrating example medium access control control elements (MAC CEs) according to embodiments of the present disclosure;

FIG. 5 illustrates a schematic diagram illustrating another process of communication for monitoring of a control channel for multicast according to embodiments of the present disclosure;

FIG. 6 illustrates an example method of communication implemented at a terminal device in accordance with some embodiments of the present disclosure;

FIG. 7 illustrates another example method of communication implemented at a terminal device in accordance with some embodiments of the present disclosure; and

FIG. 8 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz to 7125 MHz), FR2 (24.25 GHz to 71 GHz), frequency band larger than 100 GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g. signal generator, signal analyzer, spectrum analyzer, network analyzer, test terminal device, test network device, channel emulator.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device or the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

In the context of the present disclosure, the term “MBS” may be interchangeably used with “multicast”, “multicast service”, “multicast transmission” or “multicast data”. The term “multicast reception” may be interchangeably used with “MBS reception”. The term “a connected state” may be interchangeably used with “a RRC_CONNECTED state”, the term “an idle state” may be interchangeably used with “a RRC_IDLE state”, and the term “an inactive state” may be interchangeably used with “a RRC_INACTIVE state”.

As mentioned above, if a control channel is introduced for multicast session notification, solutions for monitoring of the control channel are still incomplete and need to be further developed.

In view of this, embodiments of the present disclosure provide solutions for monitoring a control channel for multicast. In one solution, a terminal device in an inactive state determines whether a control channel for multicast is to be monitored based on at least one of the following: a paging message; a timer configured for reception of a multicast session that the terminal device has joined; a modification period for monitoring of the control channel; a repetition period for monitoring of the control channel; information of the multicast session carried on the control channel; or a MAC CE indicating that the control channel is to be monitored. If the control channel is to be monitored, the terminal device monitors the control channel for acquisition of information of a multicast session that the terminal device has joined. In this way, monitoring for a control channel for multicast may be controlled. Thus, unnecessary monitoring may be avoided and power consumption on the monitoring may be reduced.

In another solution, a terminal device in an inactive state determines an identity of a subgroup associated with a multicast session that the terminal device has joined. The terminal device receives, from a network device, information of a scheduling for a control channel for multicast. Then the terminal device determines a monitoring of the control channel based on the identity of the subgroup and the information of the scheduling. In this way, terminal devices corresponding to different multicast sessions within a control channel for multicast are grouped. Thus, unnecessary monitoring may be avoided and power consumption on the monitoring may be reduced.

Principles and implementations of the present disclosure will be described in detail below with reference to the figures.

### Example of Communication Network

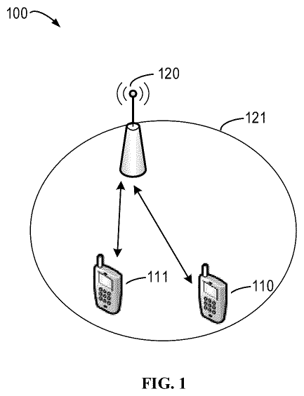

FIG. 1 illustrates a schematic diagram of an example communication network 100 in which some embodiments of the present disclosure can be implemented. As shown in FIG. 1, the communication network 100 may include terminal devices 110 and 111 and a network device 120. In some embodiments, the network device 120 may provide a serving cell (also referred to as a cell herein) 121 to serve one or more terminal devices. In this example, the terminal devices 110 and 111 are shown as being located in the cell 121 and served by the network device 120.

It is to be understood that the number of devices or cells in FIG. 1 is given for the purpose of illustration without suggesting any limitations to the present disclosure. The communication network 100 may include any suitable number of network devices and/or terminal devices and/cells adapted for implementing implementations of the present disclosure.

As shown in FIG. 1, each of the terminal devices 110 and 111 may communicate with the network device 120 via a channel such as a wireless communication channel. The communications in the communication network 100 may conform to any suitable standards including, but not limited to, Global System for Mobile Communications (GSM), Long Term Evolution (LTE), LTE-Evolution, LTE-Advanced (LTE-A), New Radio (NR), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

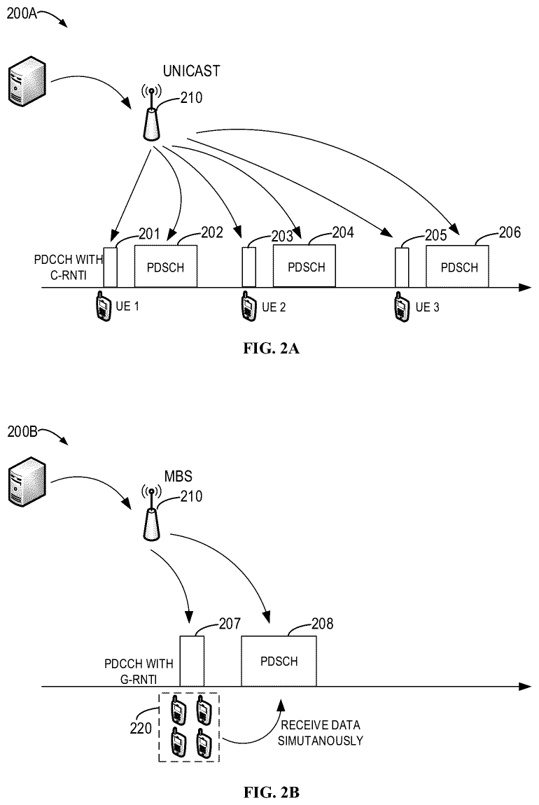

In some embodiments where the terminal device 110 is served by the network device 120, the terminal device 110 may receive a unicast service from the network device 120. FIG. 2A illustrates a schematic diagram of a unicast scenario 200A in which some embodiments of the present disclosure can be implemented. As shown in FIG. 2A, a base station 210 may transmit downlink control information (DCI) on a physical downlink control channel (PDCCH) 201 with a cell-radio network temporary identifier (C-RNTI) for UE1. In this way, UE1 may be scheduled to receive data (for example, video stream) on a physical downlink shared channel (PDSCH) 202 in unicast. Similarly, the base station 210 may transmit DCI on a PDCCH 203 with a C-RNTI for UE2 to schedule UE2 to receive the data on a PDSCH 204 in unicast. The base station 210 may transmit DCI on a PDCCH 205 with a C-RNTI for UE3 to schedule UE3 to receive the data on a PDSCH 206 in unicast.

In some embodiments where the terminal device 110 is served by the network device 120, the terminal device 110 may receive a multicast service from the network device 120. FIG. 2B illustrates a schematic diagram of a multicast scenario 200B in which some embodiments of the present disclosure can be implemented. As shown in FIG. 2B, the base station 210 may transmit DCI on a PDCCH 207 with a group-radio network temporary identifier (G-RNTI) for a set of UEs 220. In this way, the set of UEs 220 may be scheduled to receive the data on a PDSCH 208 in multicast, i.e., to receive the data simultaneously.

That is, for multicast communication service, the same service and the same specific content data are provided simultaneously to a dedicated set of UEs (i.e., not all UEs in the multicast service area are authorized to receive the data). A multicast communication service is delivered to the UEs using a multicast session. A UE can receive a multicast communication service in a connected state with mechanisms such as point-to-point (PTP) and/or PTM delivery.

In some embodiments, the terminal device 110 may receive data of MBS multicast session only in a connected state. If the terminal device 110 which joined a multicast session is in a connected state and when the multicast session starts, the network device 120 may transmit a radio resource control (RRC) reconfiguration message with relevant MBS configuration (also referred to as a multicast configuration) for the multicast session to the terminal device 110. In this case, there is no need for separate session activation notification for the terminal device 110. In some embodiments, when there is no data to be sent to the terminal device 110 for a multicast session, the network device 120 may cause the terminal device 110 to enter an inactive state.

Currently, it has been agreed that when a network configures a terminal device to continue multicast reception in an inactive state, the network may provide a PTM configuration for an activated multicast session via a RRC dedicated signaling, at least for a serving cell. It has also been agreed that a MBS control channel (MCCH) may be used in case there is a need to indicate a PTM configuration, in case there is a need for change in PTM configuration, or during mobility beyond a serving cell. It is assumed that a terminal device may only receive a multicast session after the terminal device joined the multicast session.

In this case, if a control channel such as MCCH is introduced for multicast session notification, a terminal device in an inactive state may discontinuously monitor the control channel for possible multicast session notification. Unnecessary power consumption will be caused if there is no incoming notification.

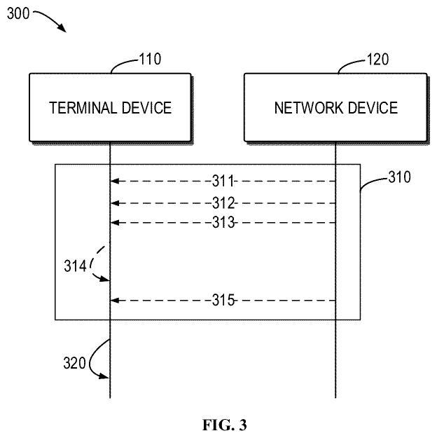

Thus, embodiments of the present disclosure provide solutions for monitoring a control channel for multicast so as to overcome the above and other potential issues. The detailed description will be made with reference to FIGS. 3 to 6 below.

In the context of the present disclosure, the term “a control channel for multicast” refers to a control channel designed for carrying a multicast related configuration. For example, the control channel may be a MCCH. However, this is merely an example and does not limit the present disclosure. It is to be understood that the control channel may be implemented by any suitable control channels existing or to be developed in future. For convenience, the term “a control channel for multicast” may also be interchangeably used with “a control channel” in the context of the present disclosure.

### Example Implementation of Control for Monitoring

FIG. 3 illustrates a schematic diagram illustrating a process 300 of communication for monitoring of a control channel for multicast according to embodiments of the present disclosure. For the purpose of discussion, the process 300 will be described with reference to FIG. 1. The process 300 may involve the terminal device 110 and the network device 120 as illustrated in FIG. 1. It is to be understood that the steps and the order of the steps in FIG. 3 are merely for illustration, and not for limitation. For example, the order of the steps may be changed. Some of the steps may be omitted or any other suitable additional steps may be added. It is assumed that the terminal device 110 is in an inactive state.

As shown in FIG. 3, the terminal device 110 may determine 310 whether a control channel for multicast is to be monitored. For illustration, some example embodiments will be described in connection with Embodiments 1 to 6 below.

### Embodiment 1

In this embodiment, the terminal device 110 may determine, based on a paging message, whether the control channel is to be monitored.

With reference to FIG. 3, the terminal device 110 may receive 311 a paging message from the network device 120. The paging message may comprise an indication indicating whether the control channel is to be monitored.

In some embodiments, the paging message may indicate a multicast session that the terminal device 110 has joined. In this case, the terminal device 110 may determine that the control channel is to be monitored. For example, an information element (IE) pagingGroupList may be used to notify the terminal device 110 whether the control channel is to be monitored. In some embodiments, if the IE pagingGroupList comprises an identity (e.g., temporary mobile group identity (TMGI) or any other forms) of the multicast session, the terminal device 110 may determine that the control channel is to be monitored.

For illustration, an example procedure may be described as below.

UE applies an information acquisition procedure to acquire MBS multicast configuration information from a control channel. A configuration of the control channel is provided by a network via e.g., dedicated RRC signaling, or system information. The procedure applies to multicast reception in RRC_INACTIVE capable UE.

UE who supports multicast reception during RRC_INACITVE shall apply the information acquisition procedure upon reception of a paging indication indicating that the UE needs to monitor the control channel. Otherwise, UE who has already acquired the control channel information is not required to monitor the control channel (e.g., as a reason of control channel update).

Upon reception of a paging message, the multicast reception in RRC_INACTIVE capable UE shall:
1> if the multicast session that the UE has joined is indicated by TMGI included in the pagingGroupList; and
1> if none of the UE-Identity included in any of the PagingRecord, if included in the Paging message, matches the UE identity allocated by upper layers:
   2> maintain in RRC_INACTIVE;
   2> acquire the MBS multicast session information (such as updated configuration, session start, session stop) on the control channel in the concerned cell.

In some embodiments, the paging message may indicate the multicast session that the terminal device 110 has joined and comprise a paging cause for the multicast session. If the paging cause indicates a monitoring of the control channel, the terminal device 110 may determine that the control channel is to be monitored.

For example, a paging cause list may be introduced for pagingGroupList. Each paging cause in the paging cause list corresponds to each TMGI in pagingGroupList, to indicate whether UE needs to monitor the control channel. For illustration, an example configuration of a paging message may be designed as below. It is to be understood that any other suitable forms are also feasible.

| | |
|---|---|
| [symbol] | SEQUENCE [symbol] |
| [symbol] | SEQUENCE [symbol] |
| [symbol] | SEQUENCE [symbol] |
| [symbol] | ENUMERATED [symbol] |

} [symbol]
indicates data missing or illegible when filed

For illustration, an example procedure may be described as below.

UE applies an information acquisition procedure to acquire MBS multicast configuration information from a control channel. A configuration of the control channel is provided by a network via e.g., dedicated RRC signaling, or system information. The procedure applies to multicast reception in RRC_INACTIVE capable UE.

UE who supports multicast reception during RRC_INACITVE shall apply the information acquisition procedure upon reception of a paging indication indicating that the UE needs to monitor the control channel. Otherwise, UE who has already acquired the control channel information is not required to monitor the control channel (as a reason of control channel update).

Upon reception of a paging message, the multicast reception in RRC_INACTIVE capable UE shall:
1> if the multicast session that the UE has joined is indicated by TMGI included in the pagingGroupList; and
1> if none of the UE-Identity included in any of the PagingRecord, if included in the Paging message, matches the UE identity allocated by upper layers:
   2> if the pagingCause with the cause set to mcch Monitoring is indicated for this TMGI:
      3> maintain in RRC_INACTIVE;
      3> acquire the MBS multicast session information (such as updated configuration, session start, session stop) on the control channel in the concerned cell.

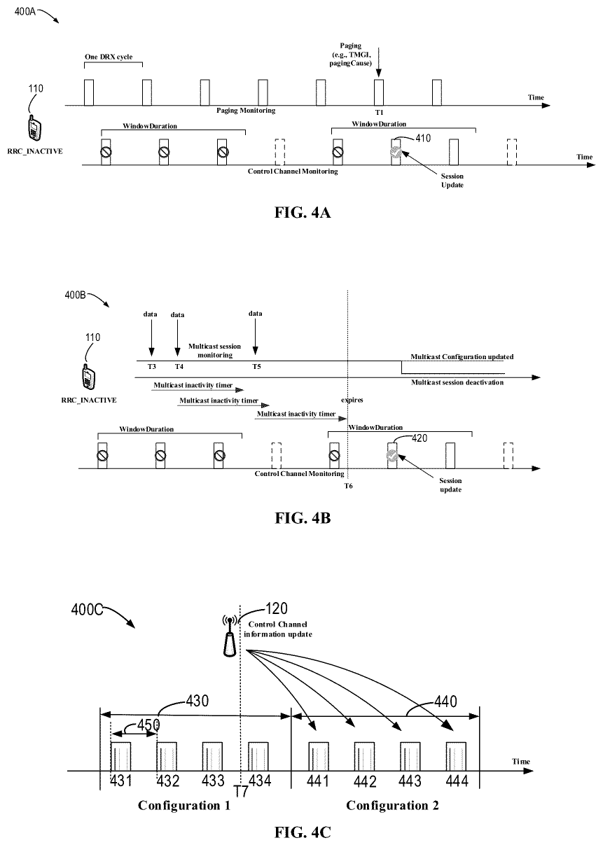

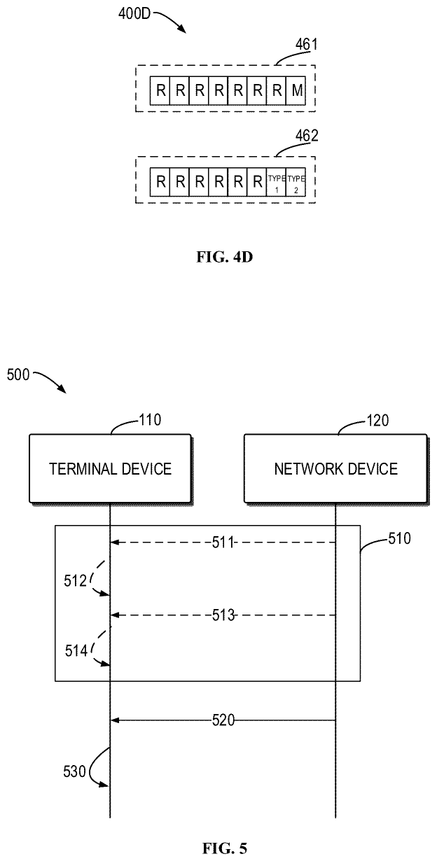

FIG. 4A illustrates a schematic diagram 400A illustrating an example monitoring of a control channel based on a paging message according to embodiments of the present disclosure. As shown in FIG. 4A, the terminal device 110 may perform a paging monitoring based on a DRX cycle. The terminal device 110 may perform the paging monitoring on an on-duration (i.e., a paging occasion). In addition, the terminal device 110 may perform a control channel monitoring based on a window. The terminal device 110 may perform the control channel monitoring on an on-duration (i.e., a control channel occasion) within the window.

With reference to FIG. 4A, a paging message may be received at a timing T1. The paging message may indicate TMGI of a multicast session that the terminal device 110 has joined. Additionally, the paging message may comprise a paging cause for the TMGI indicating that a control channel is to be monitored. As shown in FIG. 4A, the terminal device 110 may not perform the control channel monitoring until the paging message is received. At the first monitoring occasion 410 after T1, the terminal device 110 may start monitoring of the control channel for acquisition of multicast related configuration. It is to be understood that FIG. 4A is merely for illustration and is not for limitation.

In this way, a paging message may be used as a notification of a control channel monitoring. As the paging message is always monitored by a terminal device in an inactive state, no additional signaling overhead is caused. Thus, power saving may be achieved.

### Embodiment 2

In this embodiment, the terminal device 110 may determine, based on a timer, whether the control channel is to be monitored. The timer is configured for reception of a multicast session that the terminal device 110 has joined. In other words, a multicast inactivity timer may be introduced.

Continue to refer to FIG. 3, the terminal device 110 may receive 312 a configuration for the timer. For example, the timer (e.g., multicastInactivityTimer as shown) may be configured as below. It is to be understood that any other suitable forms are also feasible.

| | |
|---|---|
| [symbol] | SEQUENCE [symbol] |

| [symbol] | [symbol] |
|---|---|
| ... | |
| [symbol] | |
| [symbol] | ENUMERATED [symbol] |

[symbol]

indicates data missing or illegible when filed

In some embodiments, if data associated with the multicast session is received, the terminal device 110 may start or restart the timer. In some embodiments, if the timer expiries, the terminal device 110 may determine that the control channel is to be monitored. In some embodiments, if data associated with the multicast session is to be received, the terminal device 110 may stop monitoring the control channel.

For illustration, an example procedure may be described as below.

UE may be configured by dedicated RRC signaling or system information with a Multicast session data inactivity monitoring functionality, when receiving multicast session data during RRC_INACTIVE, the UE controls a control channel monitoring operation by configuring the timer multicastInactivityTimer.

When multicastInactivityTimer is configured, the UE shall:
1> if any medium access control (MAC) entity receives a MAC service data unit (SDU) for a MBS traffic channel (MTCH) logical channel:
   2> start or restart multicastInactivityTimer.
1> if the multicastInactivityTimer expires:
   2> indicate the expiry of the multicastInactivityTimer to upper layers (i.e., RRC).

For illustration, another example procedure may be described as below.

Upon starting receiving multicast session data during RRC_INACTIVE, the UE shall:
1> not monitor a control channel for this session.

Upon receiving the expiry of multicastInactivityTimer from lower layer (i.e., MAC) while receiving multicast session data in RRC_INACTIVE, the UE shall:
1> perform the actions upon monitoring of a control channel for this session based on the control channel configuration.

In some examples, the UE shall monitor a control channel based on a control channel configuration until re-receiving multicast data, i.e., fall back to normal control channel monitoring if the UE interested session is deactivated.

FIG. 4B illustrates a schematic diagram 400B illustrating an example monitoring of a control channel based on a timer according to embodiments of the present disclosure. As shown in FIG. 4B, upon reception of data associated with the multicast session at a timing T3, the terminal device 110 may start a multicast inactivity timer. Upon reception of data associated with the multicast session at a timing T4, the terminal device 110 may restart the multicast inactivity timer. Upon reception of data associated with the multicast session at a timing T5, the terminal device 110 may still restart the multicast inactivity timer. As there is no more data coming, the multicast inactivity timer expiries at a timing T6.

As shown in FIG. 4B, the terminal device 110 may not perform a control channel monitoring until the timing T6. The terminal device 110 may start the control channel monitoring at the first monitoring occasion 420 after the timing T6. The terminal device 110 may receive session update information based on the control channel monitoring. For example, a multicast configuration may be updated or a multicast session may be deactivated. It is to be understood that FIG. 4B is merely for illustration and is not for limitation.

In this way, if a terminal device has already started receiving a multicast session, there is no need to monitor a control channel unless there is no incoming data. Thus, power saving may be achieved.

### Embodiment 3

In this embodiment, the terminal device 110 may determine, based on a period for monitoring of a control channel, whether the control channel is to be monitored.

FIG. 4C illustrates a schematic diagram 400C illustrating a modification period and a repetition period for monitoring of a control channel according to embodiments of the present disclosure. As shown in FIG. 4C, a modification period 430 and a modification period 440 are shown. The modification period 430 comprises windows 431 to 434 and the modification period 440 comprises windows 441 to 444. Within each window, the terminal device 110 may monitor the control channel on monitoring occasions. A repetition period 450 of a window is also shown.

As shown in FIG. 4C, at timing T7 within the modification period 430, the network device 120 may expect to update information of the control channel, e.g., change from configuration 1 to configuration 2. In this case, the network device 120 may need to update the information of the control channel at the beginning of the next modification period 440. In other words, the terminal device 110 may not apply the configuration 2 until the beginning of the next modification period. That is, the terminal device 110 may still apply the configuration 1 in the window 434 after the timing T7 and may apply the configuration 2 in the windows 441 to 444 of the modification period 440.

In some embodiments, the terminal device 110 may determine, based on the modification period for monitoring of the control channel, whether the control channel is to be monitored. In some embodiments, the terminal device 110 may monitor the control channel for a predetermined number of times in the modification period. For example, the terminal device 110 may monitor the control channel only once in every modification period. With reference to FIG. 4C, within each modification period (e.g., the modification period 430 or 440) of the window, the control channel may be monitored only once.

In some embodiments, the terminal device 110 may determine, based on the repetition period for monitoring of the control channel, whether the control channel is to be monitored. In some embodiments, the terminal device 110 may monitor the control channel for a predetermined number of times in the repetition period. For example, the terminal device 110 may monitor the control channel only once in every repetition period. With reference to FIG. 4C, within each repetition period (e.g., the repetition period 450) of the window, the control channel may be monitored only once.

For example, an example procedure may be described as below.

Change of control channel (e.g., MCCH) information only occurs at specific radio frames, i.e. the concept of a modification period is used. Within a modification period, the same control channel information may be transmitted a number of times, as defined by its scheduling (which is based on a repetition period).

When the network changes (some of) the control channel information, it notifies the UEs about the change starting from the beginning of the modification period via PDCCH which schedules the control channel in every repetition in that modification period. The UE receiving multicast session in RRC_INACTIVE shall monitor a PDCCH occasion for control channel information update at least once per modification period or per repetition period (i.e., UE is not required to monitor every PDCCH occasions for a control channel).

In this way, a control channel may be monitored for a predetermined number of times in every cycle, and thus power saving may be achieved.

### Embodiment 4

In this embodiment, the terminal device 110 may determine, based on information of a scheduling for the control channel, whether the control channel is to be monitored.

Continue to refer to FIG. 3, in some embodiments, the terminal device 110 may receive 313, from the network device 120, information of a scheduling for the control channel. Upon reception of the information of the scheduling, the terminal device 110 may determine that the control channel is to be monitored.

In some embodiments, if information of a multicast session the terminal device 110 has joined is acquired from the control channel, the terminal device 110 may stop 314 monitoring the control channel on a subsequent set of occasions for the monitoring of the control channel in a period. For example, the terminal device 110 may stop monitoring the control channel on a subsequent set of occasions for the monitoring of the control channel in the modification period. In another example, the terminal device 110 may stop monitoring the control channel on a subsequent set of occasions for the monitoring of the control channel in the repetition period.

For illustration, an example procedure may be described as below.

Change of control channel (e.g., MCCH) information only occurs at specific radio frames, i.e. the concept of a modification period is used. Within a modification period, the same control channel information may be transmitted a number of times, as defined by its scheduling (which is based on a repetition period).

When the network changes (some of) the control channel information, it notifies the UEs about the change starting from the beginning of the modification period via PDCCH which schedules the control channel in every repetition in that modification period.

Upon receiving a change notification, UE receiving or interested to receive MBS services transmitted using MBS broadcast acquires the new MCCH information starting from the same slot. The UE receiving multicast session in RRC_INACTIVE UE may stop monitoring the subsequent PDCCH occasions for this modification period or repetition period. The UE applies the previously acquired control channel information until the UE acquires the new control channel information.

In this way, a control channel monitoring may be stopped once a multicast related configuration is received, and thus power saving may be achieved.

### Embodiment 5

In this embodiment, the terminal device 110 may determine, based on information of the multicast session carried on the control channel, whether the control channel is to be monitored.

In some embodiments, the terminal device 110 may acquire the information of the multicast session from the control channel and the information of the multicast session may comprise a state indication for the multicast session. In this case, the terminal device 110 may determine that the control channel is to be monitored.

For example, the information of the multicast session may be configured as below.

| | |
|---|---|
| MBS-SessionInfo::= | SEQUENCE { |

| | |
|---|---|
| mbs-SessionId | TMGI, |
| g-RNTI | RNTI-Value, |
| mtch-SchedulingInfo | DRX-ConfigPTM-Index |
| mtch-NeighbourCell | BIT STRING (SIZE(maxNeighCellMBS)) |
| pdsch-ConfigIndex | PDSCH-ConfigIndex |
| mtch-SSB-MappingWindowIndex | MTCH-SSB-MappingWindowIndex |
| sessionState | ENUMERATE {activation, deactivation, update} |

}

In this example, IEs activation, deactivation, and update may be defined as below: activation: if present in the control channel contents, indicates that the corresponding multicast session is ongoing.
deactivation: if present in the control channel contents, indicates that the corresponding multicast session is stopped.
update: if present in the control channel contents, indicates that the multicast session is still ongoing but configuration needs to be updated.

In some embodiments, if the state indication indicates activation of the multicast session, the terminal device 110 may start reception of the multicast session based on a configuration comprised in the information of the multicast session. In some embodiments, if the state indication indicates deactivation of the multicast session, the terminal device 110 may stop the reception of the multicast session while storing the configuration. In some embodiments, if the state indication indicates update of the multicast session, the terminal device 110 may acquire or re-acquire the configuration comprised in the information of the multicast session.

For illustration, an example procedure may be described as below.

When UE receives session state-activation, the UE start to receive multicast session in RRC_INACTIVE based on the configuration (also provided from the control channel (e.g., MCCH)).

When the UE receives session state-deactivation, the UE stop receiving multicast session in RRC_INACTIVE but still store the multicast configuration.

When the UE receives session state-update, the UE updates its multicast configuration based on the control channel information.

Conventionally, even if there is no such a session state indication, MCCH still can work. For example, if one session is deactivated, the corresponding IE MBS-SessionInfo may be deleted from MBS-SessionInfoList. However, if the corresponding IE MBS-SessionInfo is not deleted, UE will still monitor even if session is deactivated.

According to embodiments of the present disclosure, more precise indication is provided, and session release and session pause may be precisely differentiated. In this way, UE may not delete the multicast configuration if there is temporarily no data coming.

### Embodiment 6

In this embodiment, the terminal device 110 may determine, based on a MAC CE, whether the control channel is to be monitored. The MAC CE indicates whether the control channel is to be monitored.

Continue to refer to FIG. 3, in some embodiments, the terminal device 110 may receive 315, at a lower layer (e.g., MAC layer) of the terminal device 110, the MAC CE from the network device 120. In this case, the terminal device 110 may indicate, from the lower layer to an upper layer (e.g., RRC layer) of the terminal device 110, information of the monitoring of the control channel.

FIG. 4D illustrates a schematic diagram 400D illustrating example MAC CEs according to embodiments of the present disclosure. As shown in FIG. 4D, a MAC CE 461 may be identified by a MAC subheader with logic channel identity (LCID)=X, where X denotes a predefined integer index of (e) LCID. The MAC CE 461 may have a fixed size and consist of a single octet defined as follows:
M: indicate that UE shall start to monitor the control channel (e.g., MCCH) based on a control channel configuration.
R: reserved bit, set to 0.

Continue to refer to FIG. 4D, a MAC CE 462 may be identified by a MAC subheader with logic channel identity (LCID)=X, where X denotes a predefined integer index of (e) LCID. The MAC CE 462 may have a fixed size and consist of a single octet defined as follows:
Type 1: indicate the start of the session in the control channel (e.g., MCCH) updated information;
Type 2: indicate the modification of the control channel (e.g., MCCH) information other than the change caused by start of the session;
R: reserved bit, set to 0.

It is to be understood that a MAC CE may adopt any other suitable forms.

For illustration, an example procedure may be described as below.

The network may indicate the UE whether need to monitor the control channel (e.g., MCCH) or not by sending a MAC CE.

The MAC entity shall:
1> if the MAC entity receives the MAC CE on a Serving Cell:
   2> indicate to upper layer (i.e., RRC) the information about the control channel monitoring.

In this way, a flexible method is provided to control the behavior of monitoring of a control channel for multicast.

Continue to refer to FIG. 3, upon determination that the control channel is to be monitored, the terminal device 110 may monitor 320 the control channel. With the monitoring of the control channel, information of the multicast session may be acquired from the control channel.

With the process 300, monitoring for a control channel for multicast may be controlled. Thus, unnecessary monitoring may be avoided and power saving may be achieved.

### Example Implementation of Monitoring Based on Grouping

In some scenarios, a control channel for multicast may be used to schedule multiple MBS sessions for all UEs in a cell. Thus, unnecessary monitoring for the control channel may happen.

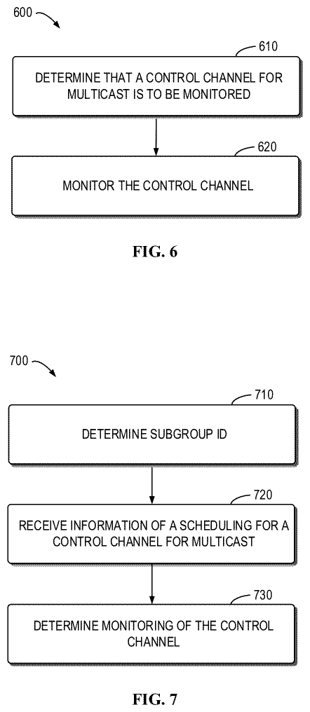

In view of this, embodiments of the present disclosure provide a solution of monitoring the control channel to overcome the above and other potential issues. The solution will be described in connection with FIG. 5 below.

FIG. 5 illustrates a schematic diagram illustrating another process 500 of communication for monitoring a control channel for multicast according to embodiments of the present disclosure. For the purpose of discussion, the process 500 will be described with reference to FIG. 1. The process 500 may involve the terminal device 110 and the network device 120 as illustrated in FIG. 1. It is to be understood that the steps and the order of the steps in FIG. 5 are merely for illustration, and not for limitation. For example, the order of the steps may be changed. Some of the steps may be omitted or any other suitable additional steps may be added. It is assumed that the terminal device 110 is in an inactive state.

As shown in FIG. 5, the terminal device 110 may determine 510 an identity of a subgroup (also referred to as a subgroup ID herein) associated with a multicast session that the terminal device 110 has joined. For illustration, some example embodiments will be described in connection with Embodiments 7 and 8 below.

### Embodiment 7

In this embodiment, a subgroup ID may be introduced in a multicast configuration for multicast reception during RRC_INACTIVE.

With reference to FIG. 5, in some embodiments, the terminal device 110 may receive 511, from the network device 120, a configuration indicating the identity of the subgroup. Then the terminal device 110 may determine 512 the identity of the subgroup from the configuration.

For example, the multicast configuration may be carried by a RRC message such as a RRCRelease message or any other dedicated RRC messages. In this case, the RRC message may be configured as shown in Opt. 1 below. In another example, the multicast configuration may be carried by system information. In this case, the system information may be configured as shown in Opt. 2 below.

| | |
|---|---|
| (Opt.1)RRCRelease/other dedicated RRC ::= | SEQUENCE { |
| multicastConfiguration | SEQUENCE { |
| subgroupId | INTEGER ((0)1..X), |

}

[symbol]

| | |
|---|---|
| (Opt.2)Systeminformation :: [symbol] | SEQUENCE { |
| multicastSessionIntoList | SEQUENCE (SIZE (1..maxNrofMulticastSession)) OF MulticastSessionInfo |

}

| | |
|---|---|
| MulticastSessionInfo ::= | SEQUENCE { |
| mbs-SessionId | TMGI, |
| g-RNTI | RNTI-Value, |

...

| | |
|---|---|
| subgroupId | INTEGER ((0)1..X), |

} [symbol]
indicates data missing or illegible when filed

In this example, IE SubgroupId may be defined as below:

SubgroupId: if provided by network, the UE shall monitor the corresponding bit in MCCH PDCCH to determine whether there is multicast session (that the UE interested) updated (e.g., session activation or deactivation, configuration modification).

### Embodiment 8

In this embodiment, a configuration used to calculate the subgroup ID may be introduced in a multicast configuration for multicast reception during RRC_INACTIVE.

Still with reference to FIG. 5, in some embodiments, the terminal device 110 may receive 513, from the network device 120, a configuration indicating a parameter associated with the identity of the subgroup. Based on the parameter and an identity of the multicast session, the terminal device 110 may determine 514 the identity of the subgroup.

In some embodiments, the parameter may comprise a number of subgroups supported by the network device 120. In some embodiments, the parameter may comprise a number of multicast sessions supported by the network device 120. In some embodiments, the parameter may comprise a predetermined integer number. It is to be understood that any combination of the above information may also be feasible.

In some embodiments, the terminal device 110 may determine the subgroup ID based on equation (1) below.

$${I}_{subgroup} = {I}_{m} mod {N}_{subgroup} \qquad ( 1 )$$

where I_{subgroup} denotes a subgroup ID, Iₘ denotes an ID of a multicast session that the terminal device 110 has joined, N_{subgroup} denotes a number of subgroups supported by the network device 120. In some embodiments, Iₘ may be TMGI of the multicast session. In some embodiments, Iₘ may be a service ID of the multicast session, i.e., an 8 Oct bit string (24 bits) included in the TMGI.

In some embodiments, the terminal device 110 may determine the subgroup ID based on equation (2) below.

$${I}_{subgroup} = ( {I}_{m} mod X ) mod {N}_{subgroup} \qquad ( 2 )$$

where I_{subgroup} denotes a subgroup ID, Iₘ denotes an ID of a multicast session that the terminal device 110 has joined, X denotes a pre-defined integer, and N_{subgroup} denotes a number of subgroups supported by the network device 120. In some embodiments, Iₘ may be TMGI of the multicast session. In some embodiments, Iₘ may be a service ID of the multicast session, i.e., an 8 Oct bit string (24 bits) included in the TMGI.

In some embodiments, the terminal device 110 may determine the subgroup ID based on equation (3) below.

$${I}_{subgroup} = [ floor ( {I}_{m} / X ) ] mod {N}_{subgroup} \qquad ( 3 )$$

where I_{subgroup} denotes a subgroup ID, Iₘ denotes an ID of a multicast session that the terminal device 110 has joined, X denotes a pre-defined integer, and N_{subgroup} denotes a number of subgroups supported by the network device 120. In some embodiments, Iₘ may be TMGI of the multicast session. In some embodiments, Iₘ may be a service ID of the multicast session, i.e., an 8 Oct bit string (24 bits) included in the TMGI.

In some embodiments, the terminal device 110 may determine the subgroup ID based on equation (4) below.

$${I}_{subgroup} = [ floor ( {I}_{m} / {N}_{m} ) ] mod {N}_{subgroup} \qquad ( 4 )$$

where I_{subgroup} denotes a subgroup ID, Iₘ denotes an ID of a multicast session that the terminal device 110 has joined, Nₘ denotes a number of multicast sessions supported by the network device 120, and N_{subgroup} denotes a number of subgroups supported by the network device 120. In some embodiments, Iₘ may be TMGI of the multicast session. In some embodiments, Iₘ may be a service ID of the multicast session, i.e., an 8 Oct bit string (24 bits) included in the TMGI.

Continue to refer to FIG. 5, upon determination of the subgroup ID, the terminal device 110 may receive 520, from the network device 120, information of a scheduling for a control channel for multicast. In some embodiments, the information of the scheduling may comprise a bit field for subgroups. The bit field may be used to identify a subgroup ID. For example, DCI format 4-0 may be used for a scheduling of the control channel. An example DCI format 4-0 may be updated as below.

Format 4_0
DCI format 4_0 is used for the scheduling of PDSCH for broadcast in DL cell.
The following information is transmitted by means of the DCI format 4_0 with CRC scrambled by MCCH-RNTI or G-
RNTI for MTCH configured by MBS-S [symbol] Info

[symbol]

| | |
|---|---|
| - | Frequency domain resource assignment - ┌log₂(N_{RB} [symbol] (N_{RB} [symbol] + 1)/2┐ bits where N_{RB} [symbol] equals to |
| | - the size of CORESET 0 if CORESET 0 is configured for the cell [symbol] and |
| | - the size of initial DL bandwidth port if CORESTE 0 is not configured for the cell. |
| - | Time domain resource assignment - 4 bits as defined in Clause 5. [symbol] .2. [symbol] of [6, TS38.2 [symbol] 4] |
| - | VRB-to-PRB mapping - 1 bit according to Table 7.3.1.2.2-5 |
| - | Modulation and coding scheme - 5 bits as defined in Clause 5. [symbol] .3 of [6, TS38.214] |
| - | Redundancy version - 2 bits as defined in Table 7.3.1.1.1-2 |
| - | MCCH change notification - 2 bits as defined in Clause x.x.x of [8, TS38.321] if the CRC of the DCI format |
| | 4_0 is scrambled by MCCH-RNTI. Otherwise, this bit field is reserved. |
| - | MCCH subgroup information - X bits if the CRC of the DCI format 4_0 is [symbol] by MCCH-RNTI. |
| | Otherwise, this bit field is reserved. |
| - | Padding bits, if required |

Zeros shall be appended to DCI format 4_0 until the payload size equals that of DCI format 1_0 monitored in common
search space in the same serving cell. [symbol]
indicates data missing or illegible when filed

In this example, some bits may be added into the DCI to identity a subgroup ID. For example, subgroup ID 1 provided to UE1 means the UE1 needs to monitor the first bit in DCI subgroup field, subgroup ID 2 provided to UE 2 means the UE1 needs to monitor the second bit in DCI subgroup field and so on.

Continue to refer to FIG. 5, the terminal device 110 may determine 530 a monitoring of the control channel based on the identity of the subgroup and the information of the scheduling.

In some embodiments, the terminal device 110 may determine, based on the identity of subgroups, a bit location in the bit field. If the bit location indicates a first bit value, the terminal device 110 may determine that the control channel is to be monitored. If the bit location indicates a second bit value different from the first bit value, the terminal device 110 may determine that the control channel is not to be monitored.

For illustration, an example procedure based on an assigned subgroup ID may be described as below.

The control channel information acquisition procedure with subgrouping is used in the cell to notify a group of UEs that are interested in a specific multicast session. A UE supporting network assigned subgrouping in RRC_INACTIVE can be assigned a subgroup ID (e.g., integer 0, 1, 2, . . . , X) via dedicated RRC signaling such as RRCRelease or SI, for multicast session monitoring.

The UE belonging to the assigned subgroup ID monitors its associated MCCH-PDCCH group bit field which indicates the corresponding multicast session update (e.g., session activation, deactivation, or session modification).

If the UE detects PDCCH and the PDCCH indicates the subgroup that the UE belongs to, the UE applies to the control channel information acquisition procedure, i.e., decode the PDSCH for acquiring the multicast related information/configuration. If the UE does not detect PDCCH or the PDCCH does not indicate the subgroup that the UE belongs to, the UE is not required to apply to the control channel information acquisition procedure, i.e., decode the PDSCH for acquiring the multicast related information/configuration.

For example, the terminal device 110 is configured with subgroup ID 2 in a RRCRelease message from the network device 120, and DCI scheduling a control channel transmission comprises a bit field for subgroups having bits 1000. In this case, the second bit in the bit field may be used to determine whether to acquire multicast session information from the control channel. In this example, the second bit is 0, and thus the terminal device 110 may determine that there is no need to acquire the multicast session information from the control channel.

In another example, the terminal device 110 is configured with subgroup ID 2 in a RRCRelease message from the network device 120, and DCI scheduling a control channel transmission comprises a bit field for subgroups having bits 0101. In this case, the second bit in the bit field may be used to determine whether to acquire multicast session information from the control channel. In this example, the second bit is 1, and thus the terminal device 110 may determine to acquire the multicast session information from the control channel.

For illustration, an example procedure based on a formula based subgroup ID may be described as below.

The control channel information acquisition procedure with subgrouping is used in the cell to notify a group of UEs that are interested in a specific multicast session. A UE supporting control channel subgrouping shall calculate a subgroup ID based the formula as specified in the specification based on the related parameters provided by the network via dedicated RRC signaling/system information.

The UE belonging to the assigned subgroup ID monitors its associated PDCCH group bit field which indicates the corresponding multicast session update (e.g., session activation, session deactivation, session modification).

If the UE detects PDCCH and the PDCCH indicates the subgroup that the UE belongs to, the UE applies to the control channel information acquisition procedure, i.e., decode the PDSCH for acquiring the multicast related information/configuration. If the UE does not detect PDCCH or the PDCCH does not indicate the subgroup that the UE belongs to, the UE is not required to apply to the control channel information acquisition procedure, i.e., decode the PDSCH for acquiring the multicast related information/configuration.

For example, the terminal device 110 is provided with a multicast configuration comprising the number of subgroups of 4, and DCI scheduling a control channel transmission comprises a bit field for subgroups having bits 1000. The terminal device 110 is interested in one multicast session (e.g., TMGI-1), and a service ID corresponding to this TMGI-1 may be 101010101010101010101010. Based on the equation (1), the subgroup ID=11184810 mod 4=2. In this case, the second bit in the bit field may be used to determine whether to acquire multicast session information from the control channel. In this example, the second bit is 0, and thus the terminal device 110 may determine that there is no need to acquire the multicast session information from the control channel.

In another example, the terminal device 110 is provided with a multicast configuration comprising the number of subgroups of 4, and DCI scheduling a control channel transmission comprises a bit field for subgroups having bits 0101. The terminal device 110 is interested in one multicast session (e.g., TMGI-1), and a service ID corresponding to this TMGI-1 may be 101010101010101010101010. Based on the equation (1), the subgroup ID=11184810 mod 4=2. In this case, the second bit in the bit field may be used to determine whether to acquire multicast session information from the control channel. In this example, the second bit is 1, and thus the terminal device 110 may determine that there is no need to acquire the multicast session information from the control channel.

With the process 500, by grouping all terminal devices which correspond to different MBS sessions within one control channel for multicast, unnecessary monitoring for the control channel will be avoided. Thus, power saving may be achieved.

It is to be understood that the processes 300 and 500 may be performed separately or in any suitable combination.

### Example Implementation of Methods

Corresponding to the above processes, embodiments of the present disclosure provide methods of communication implemented at a terminal device. These methods will be described below with reference to FIGS. 6 to 7.

FIG. 6 illustrates an example method 600 of communication implemented at a terminal device in accordance with some embodiments of the present disclosure. For example, the method 600 may be performed at the terminal device 110 as shown in FIG. 1. For the purpose of discussion, in the following, the method 600 will be described with reference to FIG. 1. It is to be understood that the method 600 may include additional blocks not shown and/or may omit some blocks as shown, and the scope of the present disclosure is not limited in this regard.

At block 610, a terminal device in an inactive state (e.g., the terminal device 110) determines that a control channel for multicast is to be monitored.

In some embodiments, the terminal device 110 may determine whether the control channel is to be monitored based on a paging message. In some embodiments, the terminal device 110 may receive from a network device (e.g., the network device 120), the paging message indicating the multicast session. In this case, the terminal device 110 may determine that the control channel is to be monitored. In some alternative embodiments, the terminal device 110 may receive, from the network device 120, the paging message indicating the multicast session and comprising a paging cause for the multicast session. If the paging cause indicates the monitoring of the control channel, the terminal device 110 may determine that the control channel is to be monitored.

In some embodiments, the terminal device 110 may determine whether the control channel is to be monitored based on a timer configured for reception of a multicast session that the terminal device 110 has joined. In some embodiments, if data associated with the multicast session is received, the terminal device 110 may start or restart the timer. If the timer expiries, the terminal device 110 may determine that the control channel is to be monitored. In some embodiments, if the data associated with the multicast session is to be received, the terminal device 110 may stop monitoring the control channel.

In some embodiments, the terminal device 110 may determine whether the control channel is to be monitored based on a modification period for monitoring of the control channel. In some embodiments, the terminal device 110 may determine that the control channel is to be monitored for a predetermined number of times in the modification period.

In some embodiments, the terminal device 110 may determine whether the control channel is to be monitored based on a repetition period for monitoring of the control channel. In some embodiments, the terminal device 110 may determine that the control channel is to be monitored for a predetermined number of times in the repetition period.

In some embodiments, the terminal device 110 may determine whether the control channel is to be monitored based on information of the multicast session carried on the control channel. In some embodiments, the terminal device 110 may receive, from the network device 120, information of a scheduling for the control channel, and determine, based on reception of the information of the scheduling, that the control channel is to be monitored. In some embodiments, if the information of the multicast session is acquired from the control channel, the terminal device 110 may stop monitoring the control channel on a subsequent set of occasions for the monitoring of the control channel in the modification period. In some embodiments, if the information of the multicast session is acquired from the control channel, the terminal device 110 may stop monitoring the control channel on a subsequent set of occasions for the monitoring of the control channel in the repetition period. In some embodiments, the terminal device 110 may acquire the information of the multicast session from the control channel, the information of the multicast session comprising a state indication for the multicast session. Based on the state indication, the terminal device 110 may determine whether the control channel is to be monitored. In some embodiments, if the state indication indicates activation of the multicast session, the terminal device 110 may start reception of the multicast session based on a configuration comprised in the information of the multicast session. In some embodiments, if the state indication indicates deactivation of the multicast session, the terminal device 110 may stop the reception of the multicast session while storing the configuration. In some embodiments, if the state indication indicates update of the multicast session, the terminal device 110 may acquire or re-acquire the configuration comprised in the information of the multicast session.

In some embodiments, the terminal device 110 may determine whether the control channel is to be monitored based on a MAC CE indicating that the control channel is to be monitored. In some embodiments, the terminal device 110 may receive, at a lower layer of the terminal device 110, the MAC CE from the network device 120; and indicate, from the lower layer to an upper layer of the terminal device 110, information of the monitoring of the control channel.

At block 620, upon determination that the control channel is to be monitored, the terminal device 110 monitors the control channel for acquisition of the information of the multicast session.

With the method 600, monitoring for a control channel for multicast may be controlled. Thus, unnecessary monitoring may be avoided and power consumption on the monitoring may be reduced.

FIG. 7 illustrates another example method 700 of communication implemented at a terminal device in accordance with some embodiments of the present disclosure. For example, the method 700 may be performed at the terminal device 110 as shown in FIG. 1. For the purpose of discussion, in the following, the method 700 will be described with reference to FIG. 1. It is to be understood that the method 700 may include additional blocks not shown and/or may omit some blocks as shown, and the scope of the present disclosure is not limited in this regard.

At block 710, a terminal device in an inactive state (e.g., the terminal device 110) determines that an identity of a subgroup associated with a multicast session that the terminal device 110 has joined.

In some embodiments, the terminal device 110 may receive, from the network device 120, a configuration indicating the identity of the subgroup.

In some embodiments, the terminal device 110 may receive, from the network device 120, a configuration indicating a parameter associated with the identity of the subgroup; and determine the identity of the subgroup based on the parameter and an identity of the multicast session. In some embodiments, the parameter may comprise at least one of the following: a number of subgroups supported by the network device; a number of multicast sessions supported by the network device; or a predetermined integer number.

At block 720, the terminal device 110 receives, from a network device (e.g., the network device 120), information of a scheduling for a control channel for multicast.

At block 730, the terminal device 110 determines a monitoring of the control channel based on the identity of the subgroup and the information of the scheduling.

In some embodiments, the information of the scheduling comprises a bit field for subgroups. In these embodiments, the terminal device 110 may determine, based on the identity of subgroups, a bit location in the bit field. If the bit location indicates a first bit value, the terminal device 110 may determine that the control channel is to be monitored. If the bit location indicates a second bit value different from the first bit value, the terminal device 110 may determine that the control channel is not to be monitored.

With the method 700, terminal devices corresponding to different multicast sessions within a control channel for multicast are grouped. Thus, unnecessary monitoring may be avoided and power consumption on the monitoring may be reduced.

### Example Implementation of Device and Apparatus

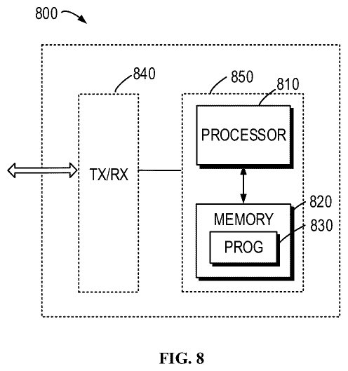

FIG. 8 is a simplified block diagram of a device 800 that is suitable for implementing embodiments of the present disclosure. The device 800 can be considered as a further example implementation of the terminal device 110 or 111 or the network device 120 as shown in FIG. 1. Accordingly, the device 800 can be implemented at or as at least a part of the terminal device 110 or the network device 120.

As shown, the device 800 includes a processor 810, a memory 820 coupled to the processor 810, a suitable transmitter (TX) and receiver (RX) 840 coupled to the processor 810, and a communication interface coupled to the TX/RX 840. The memory 810 stores at least a part of a program 830. The TX/RX 840 is for bidirectional communications. The TX/RX 840 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 830 is assumed to include program instructions that, when executed by the associated processor 810, enable the device 800 to operate in accordance with the embodiments of the present disclosure, as discussed herein with reference to FIGS. 1 to 7. The embodiments herein may be implemented by computer software executable by the processor 810 of the device 800, or by hardware, or by a combination of software and hardware. The processor 810 may be configured to implement various embodiments of the present disclosure. Furthermore, a combination of the processor 810 and memory 820 may form processing means 850 adapted to implement various embodiments of the present disclosure.

The memory 820 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 820 is shown in the device 800, there may be several physically distinct memory modules in the device 800. The processor 810 may be of any type suitable to the local technical network, and may include one or more of general purpose computers, special purpose computers, microprocessors, digital signal processors (DSPs) and processors based on multicore processor architecture, as non-limiting examples. The device 800 may have multiple processors, such as an application specific integrated circuit chip that is slaved in time to a clock which synchronizes the main processor.

In some embodiments, a terminal device comprises a circuitry configured to: determine, in an inactive state, that a control channel for multicast is to be monitored, the determining being based on at least one of the following: a paging message; a timer configured for reception of a multicast session that the terminal device has joined; a modification period for monitoring of the control channel; a repetition period for monitoring of the control channel; information of the multicast session carried on the control channel; or a medium access control control element indicating that the control channel is to be monitored; and monitor the control channel for acquisition of the information of the multicast session.

In some embodiments, a terminal device comprises a circuitry configured to: determine, in an inactive state, that an identity of a subgroup associated with a multicast session that the terminal device has joined; receive, from a network device, information of a scheduling for a control channel for multicast; and determine a monitoring of the control channel based on the identity of the subgroup and the information of the scheduling.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory (ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1 to 7. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-19. (canceled)

20. A method performed by a terminal device, comprising:
receiving a paging message;
starting monitoring transmission of Multicast/Broadcast Services Control Channel (MCCH) for multicast, in a case where the terminal device is in radio resource control (RRC) inactive state and the terminal device has joined a Multicast/Broadcast Services (MBS) session indicated by a temporary mobile group identifier (TMGI) included in the paging message; and
acquiring MBS multicast configuration message on the MCCH for multicast.

21. The method of claim 20, further comprising:
acquiring information of a multicast session on the MCCH for multicast, the information comprising information indicating the terminal device to stop reception of the multicast session.

22. A terminal device, comprising a processor configured to:
receive a paging message;
start monitoring transmission of Multicast/Broadcast Services Control Channel (MCCH) for multicast, in a case where the terminal device is in radio resource control (RRC) inactive state and the terminal device has joined a Multicast/Broadcast Services (MBS) session indicated by a temporary mobile group identifier (TMGI) included in the paging message; and
acquire MBS multicast configuration message on the MCCH for multicast.

23. The terminal device of claim 22, wherein the processor is further configured to cause the terminal device to:
acquire information of a multicast session on the MCCH for multicast, the information comprising information indicating the terminal device to stop reception of the multicast session.
